(19) United States
(12) Patent Application Publication
(10) Pub. No.: US 2005/0231161 A1
(43) Pub. Date: Oct. 20, 2005

(54) Charging accessories for portable electronic appliance chargers and methods of use thereof

(76) Inventors: James A. Jones, Fairburn, GA (US); Tommie Prothro, College Park, GA (US)

Correspondence Address: MYERS & KAPLAN, INTELLECTUAL PROPERTY LAW, L.L.C., 1899 POWERS FERRY ROAD, SUITE 310, ATLANTA, GA, 30339, US

(21) Appl. No.: 10/927,405

(22) Filed: Aug. 26, 2004

Related U.S. Application Data
(63) Continuation-in-part of application No. 10/823,999, filed on Apr. 14, 2004.

(51) Int. Cl. H02J 7/00

(52) U.S. Cl. 320/114

(57) ABSTRACT

A method and apparatus for enabling extended operating time for a cellular telephone, pager, personal digital assistant, or the like, wherein the main battery of the portable electronic devices may be recharged from an auxiliary battery contained within a portable holder, and wherein the auxiliary battery is itself recharged by connecting to an external energy source.

### TECHNICAL FIELD

The present invention relates generally to charging devices, and more specifically to portable electronic device chargers, wherein the battery from the portable electronic device may be recharged via a portable auxiliary battery or via various power sources, and wherein the portable electronic device is retained by the charger via a variable-width, slidable securing mechanism.

### BACKGROUND OF THE INVENTION

Battery chargers for cellular telephones, pagers or personal digital assistants, and/or other electronic devices, are typically powered via an electrical power source through a charger docking unit or the like. The charger docking unit is usually tethered via an electrical cord to a wall outlet, thereby precluding portability of the charger while charging the electronic device. Although other sources of power may be utilized, such as, for exemplary purposes only, solar panels, wherein the electrical energy from the solar panels is applied via an interface to the battery of the electronic device, such power sources still suffer from a lack of portability.

Still other power sources allow the insertion of primary dry cells into a package that may then connect to the charger docking unit via wires or other connectors suitably-sized- to mate with a receiver on the electrical/electronic or portable communications device. However, such power supplies do not retain the ability to be recharged in the standard fashion and alternately to be carried as an auxiliary supply combined with a communications device holder.

Some cellular telephones, pagers or personal digital assistants are carried within a holster, wherein some such holsters may incorporate an auxiliary battery therewith; The holster, which is typically sized for the specific cellular telephone, pager or personal digital assistant often must be removed to allow the communications device to seat within an associated charging device, thus prohibiting the auxiliary battery from charging within the associated charging device. Thus, such charging devices typically do not permit the contemporaneous recharging of both the auxiliary battery and the cellular telephone battery. Further, such charging devices are designed to accept a single type or manufacturer's line of portable electronic devices, and do not permit universal, or near universal, acceptance of all available communications devices.

While some or all of the above-referenced charging devices and methods therefor may well be utilized for providing auxiliary power to a cellular telephone, pager, personal digital assistant, or other suitable electrical device, such charging devices fail to adequately provide universal acceptance of differing cellular telephone, pager or personal digital assistant makes, models, configurations and connectivity interfaces, for recharging the batteries thereof.

Therefore, it is readily apparent that there is a need for a portable electronic device charger that effectively charges the battery of any selected cellular telephone, pager, personal digital assistant, or the like, thereby enabling extended operating time and avoiding the above-discussed disadvantages.

### BRIEF SUMMARY OF THE INVENTION

Briefly described, in a preferred embodiment, the present invention overcomes the above-mentioned disadvantages and meets the recognized need for such a device by providing a method and apparatus for enabling extended operating time for a cellular telephone, pager, personal digital assistant, or the like, wherein the main battery of the portable electronic devices may be recharged from an auxiliary battery contained within a portable holder, and wherein the auxiliary battery is itself recharged by connecting to an external energy source. The present invention further provides a charger capable of providing energy for replacement of the energy in the main battery the selected portable electronic device, while the charger is either connected or disconnected from the electrical power source.

According to its major aspects and broadly stated, the present invention in its preferred embodiment is a portable electronic appliance charger in the form of a docking device or holster. The docking device or holster is connected to the electrical power source during periods when the portable electronic appliance (i.e., cellular telephone, pager or personal digital assistant is not in use. While connected, the auxiliary battery in the docking device or holster is charged or recharged. Concurrently, the main battery of the portable electronic appliance can be recharged by placing the portable electronic appliance into the docking device or holster.

To transport the portable electronic appliance, the portable electronic appliance is placed in the docking device or holster, and the entire assembly is then disconnected from the electrical power source and carried upon the person of the user, preferably via an attachment clip. To utilize the portable electronic appliance, the user simply removes the portable electronic appliance from the holster. As the battery runs down, the user replaces the portable electronic appliance within the holster, thus allowing the auxiliary battery to recharge the main battery of the portable electronic appliance, thereby providing extended operating time before the portable electronic appliance and/or the holster needs to be returned to the charger.

The present invention further allows for universal application to any portable electronic appliance, or the like, wherein a sliding clip retainer removably fixes the portable electronic appliance within the docking device or holster.

Accordingly, a feature and advantage of the present invention is the selective utilization of an auxiliary battery having suitable configuration and connection for replacement of the main battery of a portable electronic appliance.

Another feature and advantage of the present invention is that the docking device or holster can be plugged into a universal charger for cellular telephones, pagers or personal digital assistants, and/or a particular charger designed for a portable cellular telephone, pager or personal digital assistant.

Still another feature and advantage of the present invention is its ability to provide extended operating time for a cellular telephone, pager or personal digital assistant.

Yet another feature and advantage of the present invention is its ability to allow the main battery of a portable electronic appliance to be recharged from a portable source.

Still yet another feature and advantage of the present invention is its ability to accept cellular telephones, pagers or personal digital assistants of differing makes, models, shapes, configurations and connectivity interfaces.

A further feature and advantage of the present invention is its ability to utilize various types of power sources.

Still a further feature and advantage of the present invention is its ability to utilize an auxiliary battery that is several times larger than the main battery of the portable electronic appliance.

These and other features and advantages of the present invention will become more apparent to one skilled in the art from the following description and claims when read in light of the accompanying drawings.

### BRIEF DESCRIPTION OF THE DRAWINGS

Having thus described the invention in general terms, the present invention will be better understood by reading the Detailed Description of the Preferred and Selected Alternate Embodiments with reference to the accompanying drawing figures, which are not necessarily drawn to scale, and in which like reference numerals denote similar structures and refer to like elements throughout, and in which:

FIG. 1A is a front view of a portable electronic appliance charger according to a preferred embodiment of the present invention;

FIG. 1B is a first side view of a portable electronic appliance charger according to a preferred embodiment of the present invention;

FIG. 1C is a second side view of a portable electronic appliance charger according to a preferred embodiment of the present invention;

FIG. 2 is a front view of a portable electronic appliance charger according to a preferred embodiment of the present invention, shown connected to an energy source;

FIG. 3A is a perspective view of a portable electronic appliance charger according to a preferred embodiment of the present invention being worn by a user;

FIG. 3B is a perspective view of a portable electronic appliance charger according to a preferred embodiment of the present invention being worn by a user while a cellular telephone is in use; and

FIG. 4 is a cutaway view of a portable electronic appliance charger according to an alternate embodiment of the present invention.

### DETAILED DESCRIPTION OF THE PREFERRED AND SELECTED ALTERNATE EMBODIMENTS

In describing the preferred and selected alternate embodiments of the present invention, as illustrated in the Figures, specific terminology is employed for the sake of clarity. The invention, however, is not intended to be limited to the specific terminology so selected, and it is to be understood that each specific element includes all technical equivalents that operate in a similar manner to accomplish similar functions.

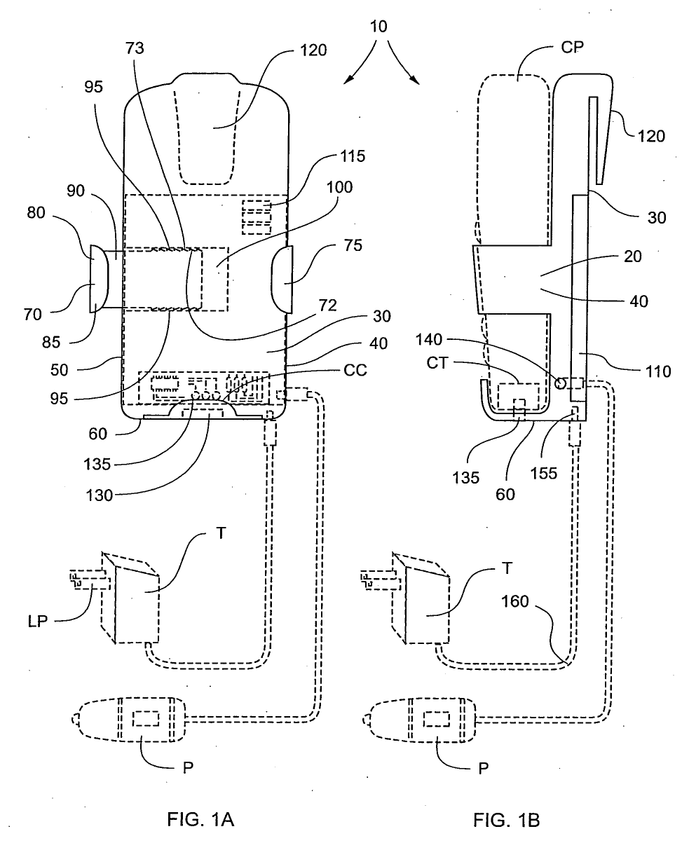

Referring now to FIGS. 1A-1C, apparatus 10 preferably comprises recharging holster cradle 20 for a communications means, such as, for exemplary purposes only, cellular telephone CP, wherein recharging cradle 20 preferably comprises back 30, first side 40, second side 50 and bottom 60. Apparatus 10 is preferably made of a formable material such as, for exemplary purposes only, plastic. It will be recognized by those in the art that any suitable formable material could be utilized without departing from the present invention.

Retaining clip 70 is preferably movably incorporated into back 30 through second side 50, via slot 100 formed in back 30. First side 40, fixed clip 75, bottom 60 and back 30 provide registration points against which cellular telephone CP rests when in cradle 20, wherein fixed clip 75 restrains cellular telephone CP from forward and/or lateral movement. Second side 50 is open to permit cellular telephone CP to be inserted into cradle 20 irrespective of the width of cellular telephone CP, thereby providing universal acceptance of different sizes of cellular telephones CP. Although cellular telephone CP is illustrated, it should be recognized that any suitable communication means could be utilized, such as, for exemplary purposes only, pagers, personal digital assistants, and so on.

Retaining clip 70 preferably comprises arm 90 and plate 80, wherein arm 90 preferably passes through slot 100 and into back 30, and wherein arm 90 preferably comprises securing means 95 for facilitating retention of cell phone CP within cradle 20. Securing means 95 is preferably any suitable securing means known within the art, such as, for exemplary purposes only, a ratcheting mechanism comprising fixed pawls 72 and ridges 73 configured to cooperatively engage one another, wherein arm 90 of retaining clip 70 is easily inserted, and wherein engagement of pawls 72 on ridges 73 retains arm 90 securely within back 30.

Auxiliary battery 110 preferably slidably engages back 30 of cradle 20, wherein once engaged, auxiliary battery 110 preferably resides in electrical communication with universal plug 135 via contacts 115 and associated wiring. As such, universal plug 135 preferably provides for electrical communication with charge controller CT of cellular telephone CP via charging connector CC of cellular telephone CP when cellular telephone CP is placed within cradle 20. Energy preferably flows from auxiliary battery 110 to the main battery of cellular telephone CP, thereby charging the main battery thereof so that cellular telephone CP may be utilized upon removal from apparatus 10. Auxiliary battery 110 can preferably be removed from cradle 20 by sliding auxiliary battery 110 therefrom.

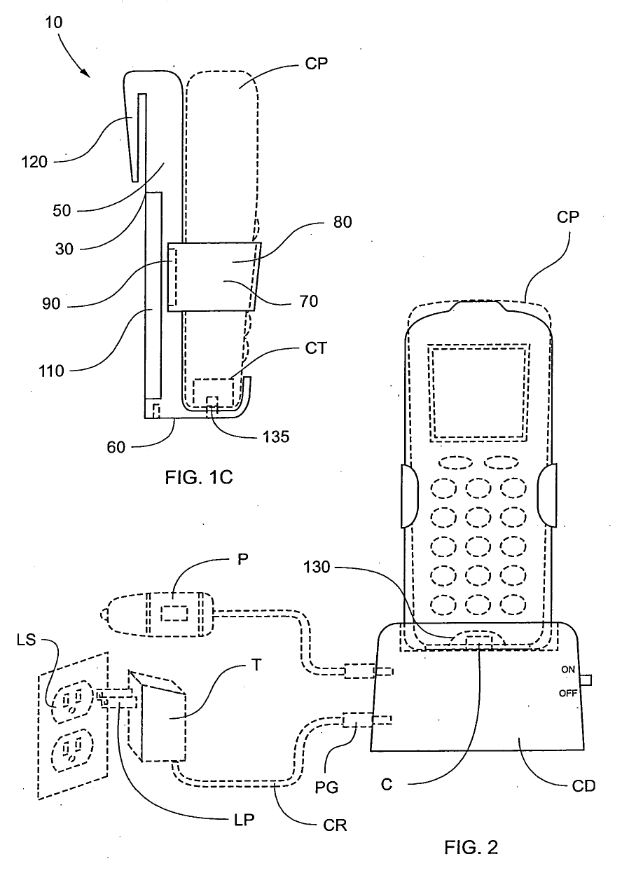

Referring now to FIG. 2, apparatus 10 is preferably placed within charging device CD, wherein universal socket 130 of apparatus 10 preferably engages connector C of charging base CD in order to provide energy to auxiliary battery 110, thereby preferably recharging auxiliary battery 110. Alternately, apparatus 10 can be connected to a conventional car lighter via plug P and charging port 140, or to mains power via line plug LP and power connector socket 150, wherein line plug LP engages line socket LS and converts energy received from line socket LS from alternating current to direct current via transformer T. In this latter embodiment, direct current electricity flows from line plug LP via cord CR to power connector plug PG, thereby providing energy to recharge auxiliary battery 110 onboard apparatus 10.

Preferably, belt clip 120 is carried by back 30 of cradle 20, wherein belt clip 120 facilitates carrying of apparatus 10 upon a person.

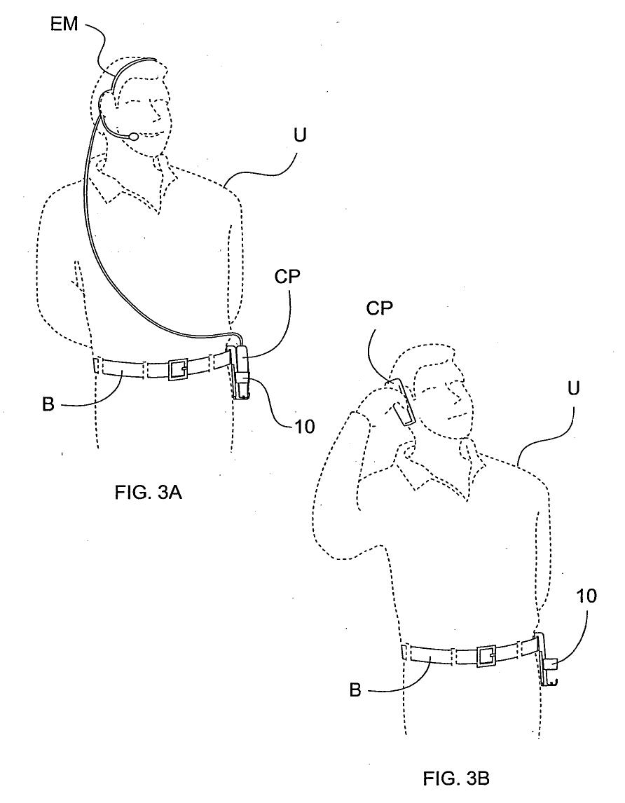

Referring now to FIGS. 3A and 3B, apparatus 10 can be worn on the belt of user U, wherein cellular telephone CP can either remain in apparatus 10 and wherein main battery of cellular telephone CP can be recharged for future use, as best shown in FIG. 3A, or wherein cellular telephone CP can be removed from apparatus 10 and utilized by user U, as best shown in FIG. 3B. While being recharged in apparatus 10, as shown in FIG. 3A, cellular telephone CP can alternately be utilized by connection of earphone/microphone combination EM to cellular telephone CP. Earphone/microphone combination EM may alternately be in communication with and incorporated as part of apparatus 10, thereby allowing user U to withdraw earphone/microphone combination EM from apparatus 10 and utilize cellular telephone CP, while cellular telephone CP remains in apparatus 10.

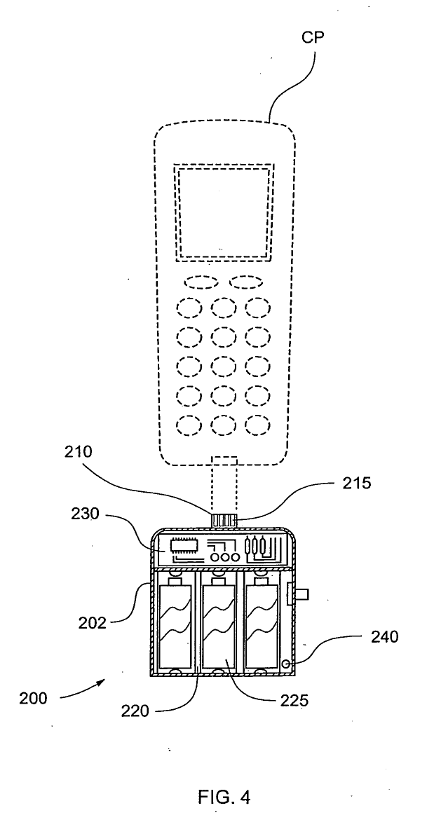

As best illustrated in FIG. 4, it is contemplated in an alternate embodiment, that apparatus 200 could be a flat battery card 202 having integral universal connector 210 suitable for connecting directly to cellular telephone CP directly via charging connector CC, and/or to charging socket 130 of apparatus 10, wherein apparatus 200 further comprises a facility for interconnection to a power source via charge port 240.

Additionally, apparatus 200 further incorporates battery unit 220, having energy cells 225, such as, for exemplary purposes only, rechargeable “gumstick” cells, and electronic charge control circuitry 230. It will be recognized by those in the art that any suitable energy cell 225 could replace the gumstick bells without deviating from the present invention. Energy from battery unit 220 is transformed to appropriate voltage and current for cellular telephone CP by electronic charge control circuitry to recharge the main battery of cellular telephone CP via electrical contacts 215 of integral universal connector 210. Battery unit 220 can be recharged via charger port 240, wherein charger port 240 is in electrical communication with electronic charge control circuitry 230, and wherein electronic charge control circuitry 230 serves to control charge to battery unit 220.

It is envisioned in an alternate embodiment that the present invention can be sized to accommodate a personal digital assistant.

It is envisioned in an alternate embodiment that the present invention can be sized to accommodate a paging device.

It is further envisioned in an alternate embodiment that auxiliary battery 110 could be attached to cradle 20 via any suitable interlocking device.

It is still further envisioned that the present invention could accommodate a digital or analog recording device.

It is also contemplated that the present invention could be sized to receive a two-way radio.

It is further contemplated that the present invention could be sized to receive a game playing device.

It is still further contemplated that the present invention could accommodate electrical devices in general.

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing the steps of the method in a certain order does not constitute any limitation on the order of the steps of the method. Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation. Accordingly, the present invention is not limited to the specific embodiments illustrated herein, but is limited only by the following claims.

1. An electronic appliance charger comprising:
at least one retaining clip, wherein said retaining clip removably secures an electronic appliance to said charger;
at least one charging interface, for placing the electronic appliance in electrical communication therewith; and
at least one battery pack in electrical communication with said at least one charging interface.

2. The electronic appliance charger of claim 1, wherein the electronic appliance is selected from the group consisting of cellular telephones, pagers, personal digital assistants, and combinations thereof.

3. The electronic appliance charger of claim 1, wherein said at least one retaining clip further comprises a slidably engagable securing means carried by said charger.

4. The electronic appliance charger of claim 3, wherein said securing means comprises a ratcheting interface.

5. The electronic appliance charger of claim 1, further comprising at least one electrical connection port.

6. The electronic appliance charger of claim 5, wherein said at least one electrical connection port comprises a jack for connecting to a vehicular power supply.

7. The electronic appliance charger of claim 5, wherein said at least one electrical connection port comprises a jack for connecting to an electrical power source.

8. The electronic appliance charger of claim 1, further comprising means for securing said charger to a person.

9. The electronic appliance charger of claim 1, wherein said at least one charging interface comprises a connector for electrically communicating with a base unit charger.

10. The electronic appliance charger of claim 1, wherein said at least one battery pack is removably secured to said electronic appliance charger.

11. The electronic appliance charger of claim 10, wherein said at least one battery pack is slidably secured to said electronic appliance charger.

12. The electronic appliance charger of claim 1, further comprising a belt clip.

13. A method of recharging a battery of a electronic appliance, said method comprising the steps of:
a) obtaining a holster comprising an auxiliary battery pack therein;
b) placing a electronic appliance in electrical communication with said holster, whereby energy flows from said auxiliary battery pack to the battery; and
c) securing the electronic appliance to said holster via a retaining clip.

14. The method of claim 13, further comprising the step of:
inserting said holster in a charger base unit.

15. The method of claim 13, further comprising the step of:
securing said holster upon a person.

16. The method of claim 13, further comprising the step of:
providing a source of energy to recharge the battery of the electronic appliance.

17. The method of claim 13, further comprising the step of:
removably connecting said holster to a power supply.

18. An apparatus for recharging electronic appliances comprising:
at least one battery pack;
at least one electronic interface, for selectively placing the electronic appliance in electrical communication with said at least one battery pack; and
at least one power supply connector for recharging said at least one battery pack.

19. The apparatus of claim 18, wherein said at least one battery pack is removably secured to said apparatus.

20. The apparatus of claim 18, wherein said apparatus is in the form of a flat card.
